(19) United States
(12) Patent Application Publication
(10) Pub. No.: US 2010/0259801 A1
(43) Pub. Date: Oct. 14, 2010

(54) SHEET FEEDER AND SCAN APPARATUS WITH SHEET-STOPPING FUNCTION

(76) Inventor: Sung-Po CHENG, Hsinchu City (TW)

Correspondence Address: Muncy, Geissler, Olds & Lowe, PLLC, 4000 Legato Road, Suite 310, FAIRFAX, VA, 22033, US

(21) Appl. No.: 12/640,566

(22) Filed: Dec. 17, 2009

(30) Foreign Application Priority Data
Apr. 9, 2009 (TW) 098111764

(51) Int. Cl. H04N 1/04; B65H 5/06

(52) U.S. Cl. 358/498; 271/264; 271/117

(57) ABSTRACT

A sheet feeder having a sheet-stopping function includes a rotating shaft, a sheet-input roller and a sheet-stopping mechanism. The rotating shaft is rotatable in a first direction and a second direction. The sheet-input roller mounted on the rotating shaft feeds a sheet. The sheet-stopping mechanism is driven by the rotating shaft to switch between a sheet-stopping state and a non-sheet-stopping state. The rotating shaft is rotated in the first direction to enable the sheet-stopping mechanism to enter the non-sheet-stopping state and allow the sheet to come into contact with the sheet-input roller. The rotating shaft is rotated in the second direction to enable the sheet-stopping mechanism to enter the sheet-stopping state and block up a passage to the sheet-input roller. A scan apparatus using the sheet feeder is also disclosed.

This application claims priority of No. 098111764 filed in Taiwan R.O.C. on Apr. 9, 2009 under 35 USC 119, the entire content of which is hereby incorporated by reference.

### BACKGROUND OF THE INVENTION

1. Field of the Invention

The invention relates to a sheet feeder and a scan apparatus, and more particularly to a sheet feeder and a scan apparatus with a sheet-stopping function.

2. Related Art

At present, image processing apparatuses, such as multi-function peripherals or scanners, are aimed to be reduced in volume and furnished with stylish industrial design. Thus, a horizontal supply tray may be designed to complement the functionality of the image processing apparatuses in order to reduce the size of the apparatuses or to achieve the special exterior requirement, and a pick-up mechanism for picking up the sheet from the supply tray may be added as well.

However, the pick-up mechanism has to work in conjunction with a sheet-stopping mechanism to prevent the sheets, which are not to be processed at the moment, from entering the sheet passageway. The conventional sheet-stopping mechanism is usually linked with the pick-up mechanism or driven by an actuator, and the conventional sheet-stopping mechanism has to be moved to an utmost point. A sensor is thus disposed to ensure that the execution of the sheet-stopping mechanism is certain and precise. In addition, the sheet-stopping mechanism is usually equipped with a spring or possesses elasticity of its own to recover to the sheet-stopping state or the non-sheet-stopping state. A driving torque of greater magnitude is therefore required to move the sheet-stopping mechanism to the utmost point. If an actuator is added to drive the sheet-stopping mechanism, the production cost is increased. If the sheet-stopping mechanism is linked with the pick-up mechanism, the sheet-stopping mechanism and the pick-up roller of the pick-up mechanism affect each other, and the variables to be considered in the design phase get more so that the design becomes complicated. In addition, a high-power driving motor has to be used. Furthermore, the size of the assembly of the conventional pick-up mechanism and the sheet-stopping mechanism cannot be effectively reduced.

### SUMMARY OF THE INVENTION

It is therefore an object of the invention to provide a sheet feeder and a scan apparatus having a sheet-stopping function. The sheet feeder, while not being driven by a motor of high power, is minimized in size and produced at a lower cost.

To achieve the above-identified object, the invention provides a sheet feeder having a sheet-stopping function. The sheet feeder includes a rotating shaft, a sheet-input roller and a sheet-stopping mechanism. The rotating shaft is rotatable in a first direction and a second direction. The sheet-input roller mounted on the rotating shaft feeds a sheet. The sheet-stopping mechanism is driven by the rotating shaft to switch between a sheet-stopping state and a non-sheet-stopping state. The rotating shaft is rotated in the first direction to enable the sheet-stopping mechanism to enter the non-sheet-stopping state and allow the sheet to come into contact with the sheet-input roller. The rotating shaft is rotated in the second direction to enable the sheet-stopping mechanism to enter the sheet-stopping state and block up a passage to the sheet-input roller.

The invention also provides a scan apparatus including an image-reading module, a sheet-transporting mechanism, a tray and a sheet feeder. The sheet feeder picks up a sheet from the tray to the sheet-transporting mechanism. The sheet-transporting mechanism transports the sheet past the image-reading module. The image-reading module acquires an image of the sheet. The sheet feeder includes a rotating shaft, a sheet-input roller and a sheet-stopping mechanism. The rotating shaft is rotatable in a first direction and a second direction. The sheet-input roller mounted on the rotating shaft feeds the sheet. The sheet-stopping mechanism is driven by the rotating shaft to switch between a sheet-stopping state and a non-sheet-stopping state. The rotating shaft is rotated in the first direction to enable the sheet-stopping mechanism to enter the non-sheet-stopping state and allow the sheet to come into contact with the sheet-input roller. The rotating shaft is rotated in the second direction to enable the sheet-stopping mechanism to enter the sheet-stopping state and block up a passage to the sheet-input roller.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a scan apparatus according to a preferred embodiment of the invention.

FIG. 2 is a pictorial view showing a sheet feeder according to the preferred embodiment of the invention.

FIG. 3 is a pictorial view showing a first state of the sheet feeder according to the preferred embodiment of the invention.

FIG. 4 is a schematic side view showing the first state of the sheet feeder according to the preferred embodiment of the invention.

FIG. 5 is a pictorial view showing a second state of the sheet feeder according to the preferred embodiment of the invention.

FIG. 6 is a schematic side view showing the second state of the sheet feeder according to the preferred embodiment of the invention.

FIG. 7 is a partially schematic illustration showing the first state of the sheet feeder according to the preferred embodiment of the invention.

FIG. 8 is a partially schematic illustration showing the second state of the sheet feeder according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

The invention provides a sheet feeder and a scan apparatus having the sheet-stopping function. The sheet feeder and the scan apparatus according to the preferred embodiment of the invention will be described with reference to the accompanying drawings.

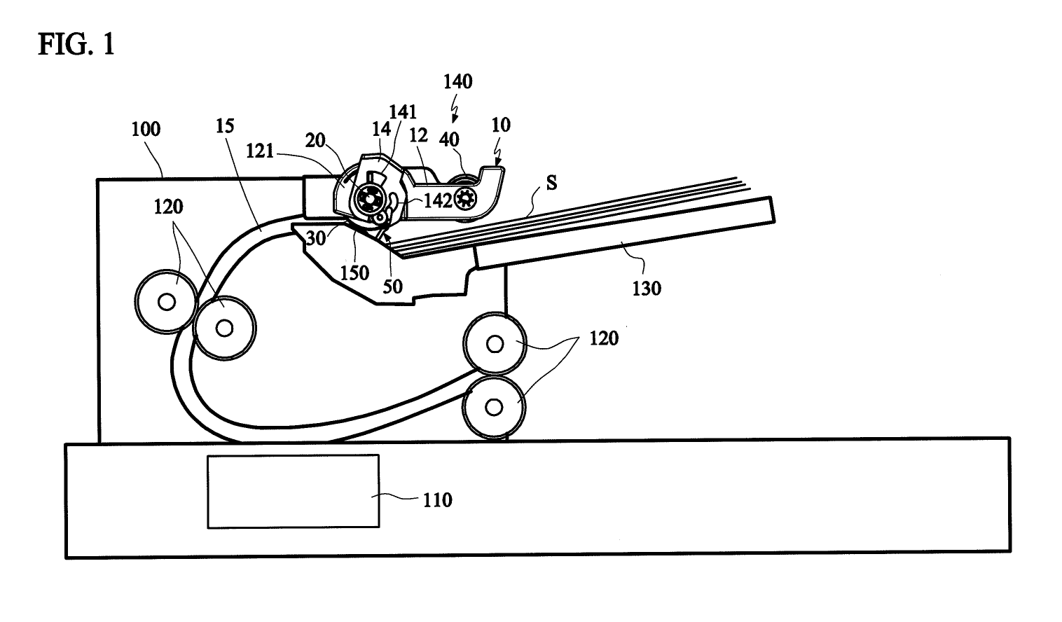

FIG. 1 is a schematic illustration showing a scan apparatus according to the preferred embodiment of the invention. Referring to FIG. 1, the scan apparatus of this embodiment includes a base 100, an image-reading module 110, a sheet-transporting mechanism 120, a tray 130 and a sheet feeder 140. The image-reading module 110 and the sheet-transporting mechanism 120 are disposed in the base 100. The tray 130 and the sheet feeder 140 are mounted on the base 100. The tray 130 can store a plurality of sheets S. The sheet feeder 140 feeds one of the sheets S from the tray 130 to the sheet-transporting mechanism 120. The sheet-transporting mechanism 120 transports the sheet S past the image-reading module 110, which acquires an image of the sheet S.

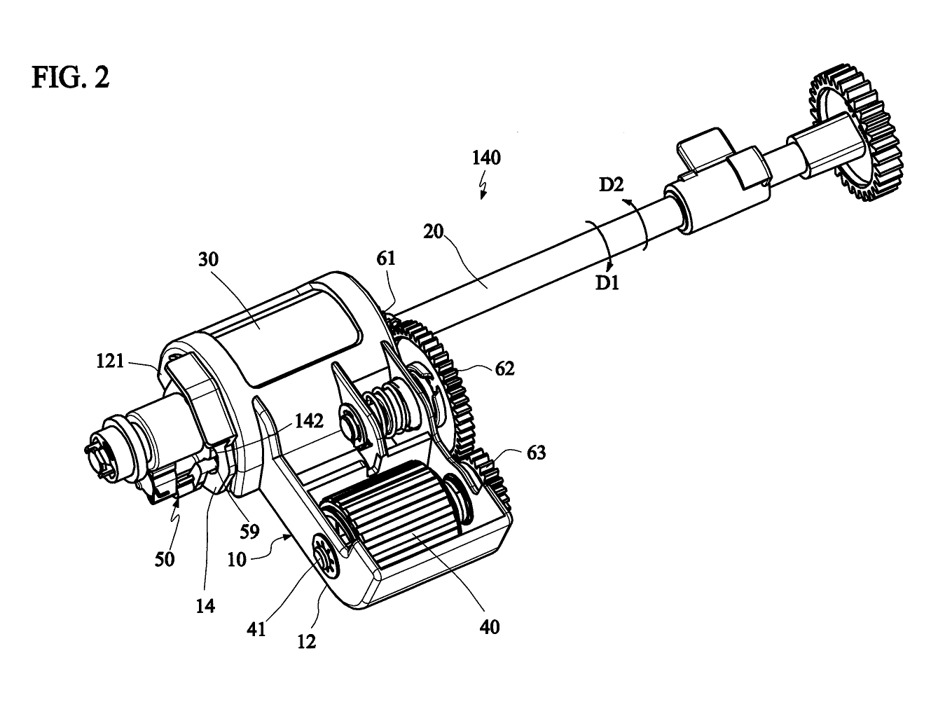

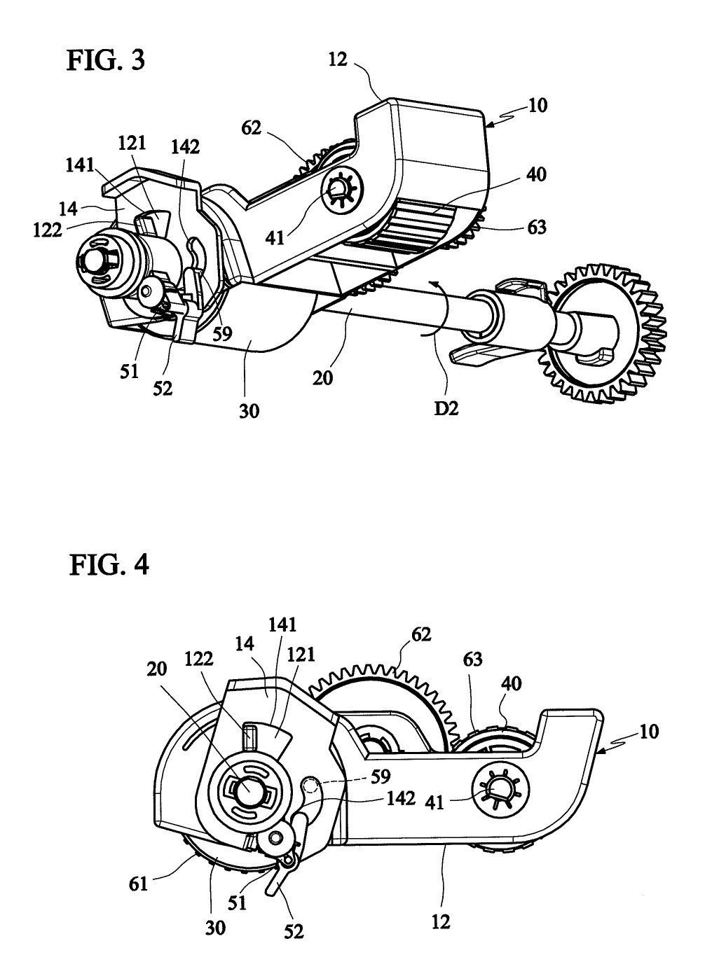

FIG. 2 is a pictorial view showing a sheet feeder according to the preferred embodiment of the invention. FIGS. 3 and 4 are respectively a pictorial view and a schematic side view showing a first state of the sheet feeder according to the preferred embodiment of the invention. Referring to FIGS. 1 to 4, the sheet feeder 140 includes a rotating shaft 20, a sheet-input roller 30 and a sheet-stopping mechanism 50. The rotating shaft 20 is rotatable in a first direction D1 and a second direction D2. In this embodiment, the first direction D1 is the clockwise direction and the second direction D2 is the counterclockwise direction. However, the invention is not particularly limited thereto.

The sheet-input roller 30 mounted on the rotating shaft 20 feeds the sheet S. In this embodiment, the sheet-input roller 30 cooperates with a frictional element 150, such as a friction pad, to feed one single sheet S to the sheet-transporting mechanism 120. The sheet-transporting mechanism 120 includes many sets of rollers for transporting the sheet S past the top side of the image-reading module 110, and then transporting out the sheet S. The sheet-stopping mechanism 50 is driven by the rotating shaft 20 to switch between a sheet-stopping state and a non-sheet-stopping state. The details will be described in the following.

In addition, the sheet feeder 140 may further include a pick-up roller 40 and a frame assembly 10. The pick-up roller 40 picks up the sheet S from the tray 130. The frame assembly 10 mounted on the rotating shaft 20 includes a frame 12 and a side plate 14. The pick-up roller 40 is disposed on the frame assembly 10, and the rotating shaft 20 is rotated to swing the pick-up roller 40 relatively to the sheet-input roller 30. Thus, the pick-up roller 40 can be either lowered down to pick up the sheet S, or lifted up to stay in a standby mode. When the next sheet needs to be picked up, the pick-up roller 40 may be again lowered down to pick up the next sheet. The side plate 14 may fix the sheet feeder 140 onto the base 100.

A first gear 61 is mounted on the rotating shaft 20, a second gear 62 is mounted on the frame 12, and a third gear 63 is mounted on a spindle 41 of the pick-up roller 40. The second gear 62 meshes with the first gear 61 and the third gear 63 such that the pick-up roller 40 may swing up and down with the rotation of the rotating shaft 20.

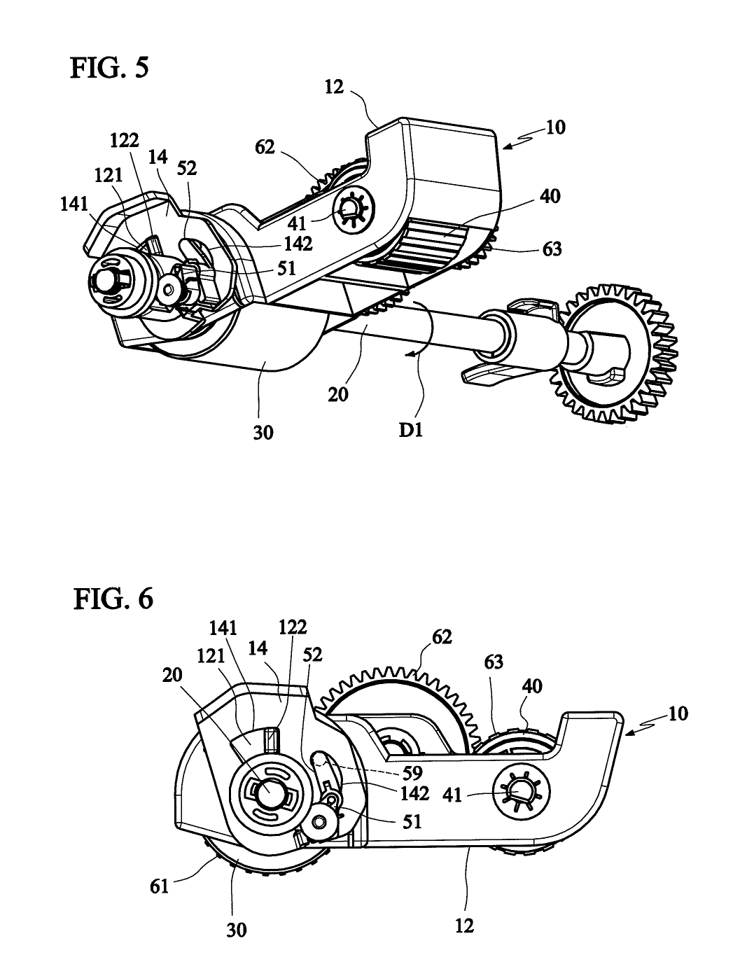

FIGS. 5 and 6 are respectively a pictorial view and a schematic side view showing a second state of the sheet feeder according to the preferred embodiment of the invention. As shown in FIGS. 3 to 6, the sheet-input roller 30 and the pick-up roller 40 are mounted on the frame 12. The side plate 14 is mounted on the rotating shaft 20 and coaxially to the frame 12, and the sheet-stopping mechanism 50 is rotatably connected to the side plate 14. In this embodiment, the side plate 14 is disposed next to a side surface 121 of the frame 12. The side surface 121 is formed with a projection 122, and the side plate 14 includes a first slot 141. The projection 122 is accommodated within the first slot 141 to restrict a rotation angle of the frame 12 relative to the side plate 14. The sheet-stopping mechanism 50 includes a first body 51 and a second body 52. The sheet-stopping mechanism 50 may further include a guiding rod 59, which is slidably accommodated within a second slot 142 of the side plate 14.

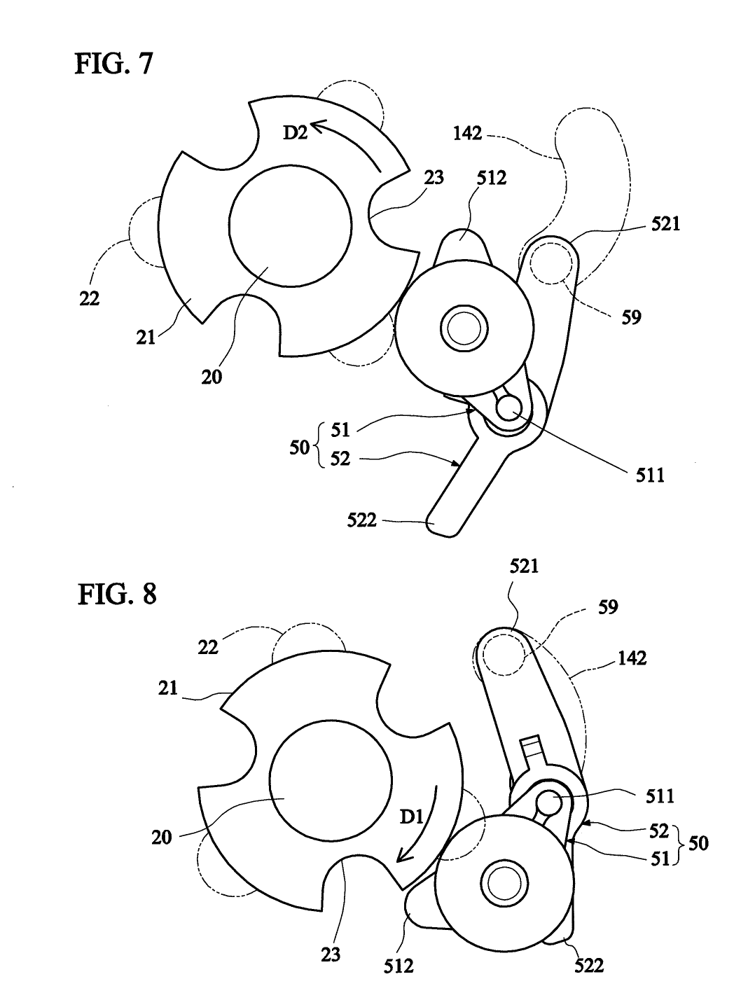

FIGS. 7 and 8 are partially schematic illustrations respectively showing the first state and the second state of the sheet feeder according to the preferred embodiment of the invention. Referring to FIGS. 7 and 8, the sheet feeder further includes a driving member 21, mounted on the rotating shaft 20 and rotated with the rotation of the rotating shaft, for driving the first body 51 as the rotating shaft 20 is rotated. The driving member 21 has a concave portion 23 or a convex portion 22. The first body 51 includes the other end 512, which cooperates with the concave portion 23 or the convex portion 22 of the driving member 21 to drive the first body 51. The second body 52 is rotatably connected to one end 511 of the first body 51, and one end 522 of the second body 52 serves as a stopping end for stopping the sheet or sheets. In this embodiment, the guiding rod 59 is disposed on the other end 521 of the second body 52. The driving member 21 may also have concave portions or convex portions separately distributed on the outer periphery of the driving member 21. Consequently, the sheet-stopping mechanism can immediately switch its state when the rotation direction of the rotating shaft is changed.

The first state is the sheet-stopping state, and the second state is the non-sheet-stopping state. Generally speaking, when the scan apparatus does not perform the scan procedure, the sheet-stopping mechanism 50 is switched to the sheet-stopping state to prevent multiple sheets from entering the nip between the sheet-input roller and the friction pad in case that the user unintentionally inserts the sheets into the nip. When the scan apparatus starts the scan procedure, the sheet-stopping mechanism 50 is switched to the non-sheet-stopping state to facilitate the sheet feeder in picking up the sheet from the tray, and in feeding the sheets, one by one, into a sheet passageway 15 so that the image scan step can be performed. The rotating shaft 20 is rotated in the first direction D1 to enable the sheet-stopping mechanism 50 to enter the non-sheet-stopping state and allow the sheet S to come into contact with the sheet-input roller 30. As shown in FIGS. 5, 6 and 8, when being switched to the non-sheet-stopping state, the driving member 21 is rotated in the first direction D1 and drives the first body 51, thereby causing the one end 522 of the second body 52, where the sheet-stopping plate is disposed, to retract because it is linked with the first body 51. Thus, no blocker exists in the passageway between the pick-up roller 40 and the sheet-input roller 30, and the sheet S may thus be smoothly fed to the sheet-input roller 30. Oppositely, the rotating shaft 20 is rotated in the second direction D2 to enable the sheet-stopping mechanism 50 to enter the sheet-stopping state and block up a passage to the sheet-input roller 30 and prevent the sheet S from entering the nip between the sheet-input roller and the friction pad. As shown in FIGS. 3, 4 and 7, when being switched to the sheet-stopping state, the driving member 21 is rotated in the second direction D2 and drives the first body 51, thereby causing the one end 522 of the second body 52 to protrude so that the sheet S is stopped in front of the sheet-input roller 30. In this embodiment, which is different from the prior art where the sheet-stopping plate is disposed between the sheet-input roller and the pick-up roller, the sheet-stopping mechanism and its sheet-stopping plate of this invention are mounted on the lateral side of the sheet-input roller. In addition, the width of the sheet-stopping surface of the sheet-stopping plate of this invention is much smaller than the axial width of the sheet-input roller or the pick-up roller.

This present invention utilizes the exterior formation of the components and the interaction there among to accomplish the operation of the sheet-stopping mechanism, and thus enhances the execution of the sheet-stopping mechanism. For example, at the moment the rotating shaft is rotated, the state of the sheet-stopping mechanism is switched. According to the present invention, the overall size of the sheet-stopping mechanism can be effectively reduced. In addition, the sheet feeder does not need a sensor to detect the action of the sheet-stopping mechanism for ensuring the correctness and certainty in the sheet-stopping operation. Since no sensor is needed, the manufacturing cost can be reduced. Furthermore, the sheet-stopping operation of the sheet-stopping mechanism does not directly relate to the up and down swing of the pick-up roller. Instead, the rotation direction of the rotating shaft controls the sheet-stopping operation of the sheet-stopping mechanism. The sheet-stopping mechanism is independent of the swinging components, such as the frame assembly and the pick-up roller, and the angle of the frame assembly. Thus, when the sheets are being fed, the frame assembly and the pick-up roller need not swing up and down but can always be kept in the state of contacting with the sheet, and the pick-up roller picks up the sheet in the tray only when it is being rotated. Furthermore, since the motor for driving the sheet-stopping mechanism do not need to overcome a large torque and it drives a lighter-weighted sheet-stopping mechanism, the chance to overload the motor is slim.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A sheet feeder having a sheet-stopping function, the sheet feeder comprising:
a rotating shaft, rotatable in a first direction and a second direction;
a sheet-input roller, mounted on the rotating shaft, for feeding a sheet; and
a sheet-stopping mechanism driven by the rotating shaft to switch between a sheet-stopping state and a non-sheet-stopping state, wherein:
the rotating shaft is rotated in the first direction to enable the sheet-stopping mechanism to enter the non-sheet-stopping state and allow the sheet to come into contact with the sheet-input roller; and
the rotating shaft is rotated in the second direction to enable the sheet-stopping mechanism to enter the sheet-stopping state and block up a passage to the sheet-input roller.

2. The sheet feeder according to claim 1, further comprising a driving member, mounted on the rotating shaft, for driving the sheet-stopping mechanism as the rotating shaft is rotated.

3. The sheet feeder according to claim 2, wherein the driving member comprises a concave portion for driving the sheet-stopping mechanism.

4. The sheet feeder according to claim 2, wherein the driving member comprises a convex portion for driving the sheet-stopping mechanism.

5. The sheet feeder according to claim 2, wherein the sheet-stopping mechanism comprises:
a first body driven by the driving member; and
a second body rotatably connected to one end of the first body, wherein one end of the second body serves as a sheet-stopping end.

6. The sheet feeder according to claim 1, further comprising:
a pick-up roller for picking up the sheet; and
a frame assembly mounted on the rotating shaft, wherein the pick-up roller is mounted on the frame assembly, and the rotating shaft is rotated to swing the pick-up roller relatively to the sheet-input roller.

7. The sheet feeder according to claim 6, wherein the frame assembly comprises:
a frame, wherein the sheet-input roller and the pick-up roller are mounted on the frame; and
a side plate mounted on the rotating shaft and coaxially to the frame, wherein the sheet-stopping mechanism is rotatably connected to the side plate.

8. The sheet feeder according to claim 7, wherein the frame comprises a side surface, and the side plate is disposed next to the side surface.

9. The sheet feeder according to claim 8, wherein the side surface is formed with a projection, the side plate comprises a first slot, and the projection is accommodated within the first slot to restrict a rotation angle of the frame relative to the side plate.

10. The sheet feeder according to claim 8, wherein the side plate comprises a second slot, the sheet-stopping mechanism comprises a guiding rod slidably accommodated within the second slot.

11. A scan apparatus, comprising:
an image-reading module;
a sheet-transporting mechanism;
a tray; and
a sheet feeder for picking up a sheet from the tray to the sheet-transporting mechanism, wherein the sheet-transporting mechanism transports the sheet past the image-reading module, the image-reading module acquires an image of the sheet, and the sheet feeder comprises:
a rotating shaft, rotatable in a first direction and a second direction;
a sheet-input roller, mounted on the rotating shaft, for feeding the sheet; and
a sheet-stopping mechanism driven by the rotating shaft to switch between a sheet-stopping state and a non-sheet-stopping state, wherein:
the rotating shaft is rotated in the first direction to enable the sheet-stopping mechanism to enter the non-sheet-stopping state and allow the sheet to come into contact with the sheet-input roller; and
the rotating shaft is rotated in the second direction to enable the sheet-stopping mechanism to enter the sheet-stopping state and block up a passage to the sheet-input roller.

12. The scan apparatus according to claim 11, wherein the sheet feeder further comprises a driving member, mounted on the rotating shaft, for driving the sheet-stopping mechanism as the rotating shaft is rotated.

13. The scan apparatus according to claim 12, wherein the driving member comprises a concave portion for driving the sheet-stopping mechanism.

14. The scan apparatus according to claim 12, wherein the driving member comprises a convex portion for driving the sheet-stopping mechanism.

15. The scan apparatus according to claim 12, wherein the sheet-stopping mechanism comprises:
a first body driven by the driving member; and
a second body rotatably connected to one end of the first body, wherein one end of the second body serves as a sheet-stopping end.

16. The scan apparatus according to claim 11, wherein the sheet feeder further comprises:
a pick-up roller for picking up the sheet; and
a frame assembly mounted on the rotating shaft, wherein the pick-up roller is mounted on the frame assembly, and the rotating shaft is rotated to swing the pick-up roller relatively to the sheet-input roller.

17. The scan apparatus according to claim 16, wherein the frame assembly comprises:
a frame, wherein the sheet-input roller and the pick-up roller are mounted on the frame; and
a side plate mounted on the rotating shaft and coaxially to the frame, wherein the sheet-stopping mechanism is rotatably connected to the side plate.

18. The scan apparatus according to claim 17, wherein the frame comprises a side surface, and the side plate is disposed next to the side surface.

19. The scan apparatus according to claim 18, wherein the side surface is formed with a projection, the side plate comprises a first slot and the projection is accommodated within the first slot to restrict a rotation angle of the side plate relative to the frame.

20. The scan apparatus according to claim 18, wherein the side plate comprises a second slot, and the sheet-stopping mechanism comprises a guiding rod slidably accommodated within the second slot.
